(19) United States
(12) Patent Application Publication
(10) Pub. No.: US 2026/0010187 A1
(43) Pub. Date: Jan. 8, 2026

(54) Load Balancing of Parallel-Connected Output Channels of a Power Supply Apparatus

(71) Applicant: Siemens Aktiengesellschaft, Muenchen (DE)

(72) Inventor: Markus TROYER, Neulengbach (AT)

(21) Appl. No.: 19/258,382

(22) Filed: Jul. 2, 2025

(30) Foreign Application Priority Data
Jul. 5, 2024 (EP) 24186850

(51) Int. Cl. G05F 1/46

(52) U.S. Cl. CPC G05F 1/46

(57) ABSTRACT

A power supply apparatus, in particular an electronic fuse for a power supply, includes a first set of output channels and a controller for load balancing between the output channels of the first set, wherein a first number of output channels in the first set is greater than or equal to two, where the output channels of the first each have a current regulator and a switching element, the current regulators are configured to control the switching element in its respective output channel, where the output channels of the first set each have an instantaneous output current and a rated current, and where it is possible for the output channels of the first set (M₁) to be connected in parallel.

### BACKGROUND OF THE INVENTION

### 1. Field of the Invention

The present invention relates generally to the field of electrical engineering and, in particular to the field of power electronics and power supply facilities and, more particularly, relates to a power supply apparatus, in particular an electronic fuse, or a method for load balancing of parallel-connected output channels of the power supply apparatus, in particular an electronic fuse.

The invention is described hereinafter with reference to the example of electronic fuses. However, the aforementioned problems arise with power supply apparatuses in general. The solution to the aforementioned problems by way of the invention can also be used for power supply apparatuses.

### 2. Description of the Related Art

A parallel connection of output channels in electronic fuses enables a cost-effective power extension of individual output channels of electronic fuses. As the output power of the individual output channels may vary greatly in the application, the definition of the rated current is in many cases controversial. While a control and regulation facility together with sensors manages with currents that are already low, drive applications may well require 20A and more.

Electronic fuses offer several output channels for this purpose, in order to be able to set up different power circuits and thus increase system availability via selectivity. However, as this is one of the advantages of electronic fuses compared to conventional fuses or circuit breakers, this must be taken into account in the circuit design.

High rated currents require more powerful and thus more costly electronic switches or MOSFETs and, in addition, place their own demands on the circuitry design. Lower currents, for example, require higher impedance shunts, which in turn cause too much power loss in high-current applications.

In practice, rated currents of approx. 10A have become established. Likewise, in demand are devices with 5A or 3A in NEC Class 2 applications. While the latter two tend to be used for control, regulation and visualization tasks, power expansion through parallel connection is of little interest for such devices.

In applications with 10A rated current, there may certainly be interest in power expansions. As mentioned previously, the parallel connection of individual output channels offers a cost-effective alternative to expensive designs that accommodate several channels with different rated currents. Such designs make sense in specific applications but are rather difficult to design because the flexibility of possible applications would be severely limited. Examples of this are temperature deratings, and/or structural conditions.

In parallel operation of MOSFETs, two effects are decisive for unequal current distribution between the branches. In dynamic switching operation, current distribution is determined by the threshold voltage. The MOSFET with the lower switch-on threshold is the first to switch on and the last to switch off and thus assumes a large proportion of the switching losses. As the threshold voltage decreases with increasing temperature, this effect increases as the operating temperature increases.

In stationary mode, the respective R_{DS,on} determines the current distribution. The MOSFET with the lower resistance assumes the greater current flow. However, the R_{DS,on} increases with increasing temperature, which results in an equalizing effect. Due to the higher power loss, the MOSFET heats up more with higher current, making its R_{DS,on} more highly resistive and thus reducing the current flow.

Nonetheless, it cannot be assumed in the realization of the circuit that the thermals alone are sufficient to balance the currents in the parallel branches. On the one hand, as a component parameter the R_{DS,on} is subject to certain manufacturing tolerances, on the other hand, even small differences in the circuit design as well as additional tolerances of components in the parallel branch are sufficient to cause unequal current distribution.

This relationship is illustrated in FIG. 1. A check using the current divider rule shows, with fictitious values, the size of the deviation for a first output channel conforms to the relationship

$${I}_{C h 1} = {I}_{L o a d} * \frac{{R}_{C h 2}}{{R}_{Ch 1} + {R}_{C h 2}} = 10 A * \frac{4.2 m Ω}{3.4 m Ω + 4.2 m Ω} = 5.526 A$$

and for a second output channel conforms to the relationship

$${I}_{C h 2} = {I}_{L o a d} * \frac{{R}_{Ch 1}}{{R}_{Ch 1} + {R}_{C h 2}} = 10 A * \frac{3.4 m Ω}{3.4 m Ω + 4.2 m Ω} = 4.474 A$$

The example shows that a deviation of 800μΩ between the output channels can already cause a difference of more than one ampere. It should also be taken into consideration that the current is incorporated quadratically into the power loss of the MOSFET.

The literature describes several options for load balancing in parallel circuits, with passive methods being preferred.

As described above, the line resistance R_{DS,on} of MOSFETs with a positive coefficient is temperature-dependent, i.e., the MOSFET exhibits an increasingly high impedance with rising temperatures. In a parallel circuit, this leads to natural load balancing because the MOSFET that carries the higher current also has higher losses, which causes the component to heat even more.

Another common method is to force an equalization via additional resistors. If, for example, shunt resistors are selected at a level at which the line resistance of the MOSFETs have less influence, then the load distribution is essentially determined by the tolerances of the shunt resistors. Such resistors inherently have low tolerances. Consequently, good results can be achieved. However, the disadvantage of this approach is the higher power loss of the overall circuit, which must be dissipated within a device. These losses are proportional to the square of the current. Consequently, this technology is more suitable for low-current applications.

EP 2 831 990 B1 describes an active control method for load balancing. Here, load balancing occurs by regulating the output voltages of at least one power section at defined current thresholds. The disadvantage of this solution is a voltage drop that is higher than absolutely necessary to realize load balancing.

The aforementioned problems of parallel connection of output channels were described above with regard to electronic fuses. However, they also occur in the parallel connection of output channels of power supply apparatuses in general.

### SUMMARY OF THE INVENTION

In view of the foregoing, it is an object of the present invention to provide a power supply apparatus, in particular an electronic fuse for a power supply, which enables low-loss load balancing at any operating point.

This and other object and advantages are achieved in accordance with the invention by a power supply apparatus, in particular an electronic fuse for a power supply, comprising a first set of output channels and a controller for load balancing between the output channels of the first set, wherein first number of output channels in the first set is greater than or equal to two, the output channels of the first set each comprises a current regulator and a switching element, the current regulator is configured to control the switching element in its respective output channel, the output channels of the first set each have an instantaneous output current and a rated current, and where it is possible for the output channels of the first set to be connected in parallel. In accordance with the invention, the controller is configured, in the case of a parallel connection of at least two output channels of the first set, to detect the instantaneous output currents of the output channels of the first set, determine output channel utilization levels of the output channels of the first set, where a respective output channel utilization level is a ratio between the instantaneous output current and the rated current of the respective output channel. The controller is further configured, in the case of the parallel connection of at least two output channels of the first set to determine a second set of output channels, where the second set is a subset of the first set, a second number of output channels in the second set is at least one less than the first number, and where the second set includes at least that output channel with the highest output channel utilization level and not including at least that output channel with the lowest output channel utilization level. Moreover, the controller is further configured, in the case of the parallel connection of at least two output channels of the first set, to control the current regulator of the output channels of the second set such that the output channel utilization levels of the output channels of the second set decrease and load balancing occurs between the output channels of the first set.

The main aspect of the invention is that at least the output channel with the lowest output channel utilization level is not included in the second set and is therefore not regulated by the control unit for load balancing. This ensures that this output channel assumes a current when one or more other output channels are switched off and its output channel utilization level increases, with load balancing between the output channels occurring as a result. Furthermore, the load is therefore decisive for the output current in every operating position.

Each of the switching elements can also be a power section comprising a plurality of components.

The number of output channels in the second set can also be one so that the second set comprises an individual output channel.

Furthermore, it is advantageous if the switching elements are electronic switches, where the current regulators are configured to set the switching element in its respective output channel to a current limiting mode and thus limit the instantaneous output current of its respective output channel. This measure enables optimum and low-loss load balancing.

It is also advantageous if the current limiting mode is a linear mode or a pulsed mode. This measure enables optimum and low-loss load balancing.

It is also advantageous if the electronic switches are field-effect transistors, bipolar transistors or Insulated Gate Bipolar Transistors (IGBTs). This measure enables optimum and low-loss load balancing.

It is also advantageous if the controller is configured to provide each current regulator of the second set with an internal reference variable, where the internal reference variable is a current setpoint that is dependent on the output channel utilization level of the output channel associated with the current regulator. This measure further increases the stability of the regulation and enables load balancing to be carried out more quickly and with less loss.

It is also advantageous if the current regulators of the first set are configured to determine an internal manipulated variable for the switching element in its respective output channel from a difference between the internal reference variable and an internal control variable, which is formed by the instantaneous current in the respective output channel associated with the current regulators. This measure further increases the stability of the regulation and enables load balancing to be implemented more quickly and with less loss.

It is also advantageous if the controller is configured to determine the internal reference variable for the current regulator of the second set from a difference between an external reference variable and an external control variable assigned to the respective output channel of the current regulator. This measure further increases the stability of the regulation and enables load balancing to be implemented more quickly and with less loss.

It is also advantageous if the external reference variable is an overall utilization level of the first set of output channels, where the controller is configured to form the overall utilization level as a ratio between the sum of the instantaneous output currents of the output channels of the first set to the sum of the rated currents of the output channels of the first set, and the external control variable assigned to the output channel is in each case a difference between the overall utilization level and the output channel utilization level of the output channel. This measure further increases the stability of the regulation and enables load balancing to be implemented more quickly and with less loss. In addition, each output channel being assigned an external control variable makes it possible for a plurality of external manipulated variables to be formed by the master controller, for this plurality of external manipulated variables to be transmitted to the output channels as a plurality of internal reference variables and thus for a plurality of output channels to be individually controlled.

It is also advantageous if the external reference variable is an arithmetic mean of the instantaneous output currents of the output channels of the first set, and the external control variable assigned to the output channel is a difference between the instantaneous output currents of the output channels of the first set. This measure further increases the stability of the regulation and enables load balancing to be carried out more quickly and with less loss. This measure is also particularly suitable for output channels with similar rated currents.

It is also advantageous if the external reference variable is an arithmetic mean of the instantaneous output currents of the output channels of the first set, and the external control variable assigned to the output channel is a mean absolute deviation of the instantaneous output currents of the output channels of the first set from the arithmetic mean of the instantaneous output currents of the output channels of the first set. This measure further increases the stability of the regulation and enables load balancing to be carried out more quickly and with less loss. This measure is also particularly suitable for load balancing between more than two output channels.

It is also advantageous if the controller is configured to control the current regulators of the output channels of the second set as a function of reaching or exceeding a threshold value of the external control variable. This measure further increases the stability of the regulation and enables load balancing to be implemented more quickly and with less loss.

It is also advantageous if the power supply apparatus is an electronic fuse for a power supply. The power supply apparatus is particularly suitable for use as an electronic fuse.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described and explained in more detail hereinafter with reference to the exemplary embodiments shown in the figures, in which:

FIG. 1 is an illustration of a circuit diagram of two parallel branches of an electronic fuse;

FIG. 2 is an illustration of a circuit diagram of an exemplary first embodiment of an electronic fuse in accordance with the invention;

FIG. 3 is an illustration of a circuit diagram of an exemplary second embodiment of an electronic fuse in accordance with the invention;

FIG. 4 is a graphical plot of a current of two output channels of an electronic fuse in accordance with the second embodiment of the invention;

FIG. 5 is an exemplary flow chart of steps which are performed by the electronic fuse in accordance with the second embodiment; and

FIG. 6 is an illustration of a circuit diagram of an exemplary third embodiment of an electronic fuse accordance with the invention.

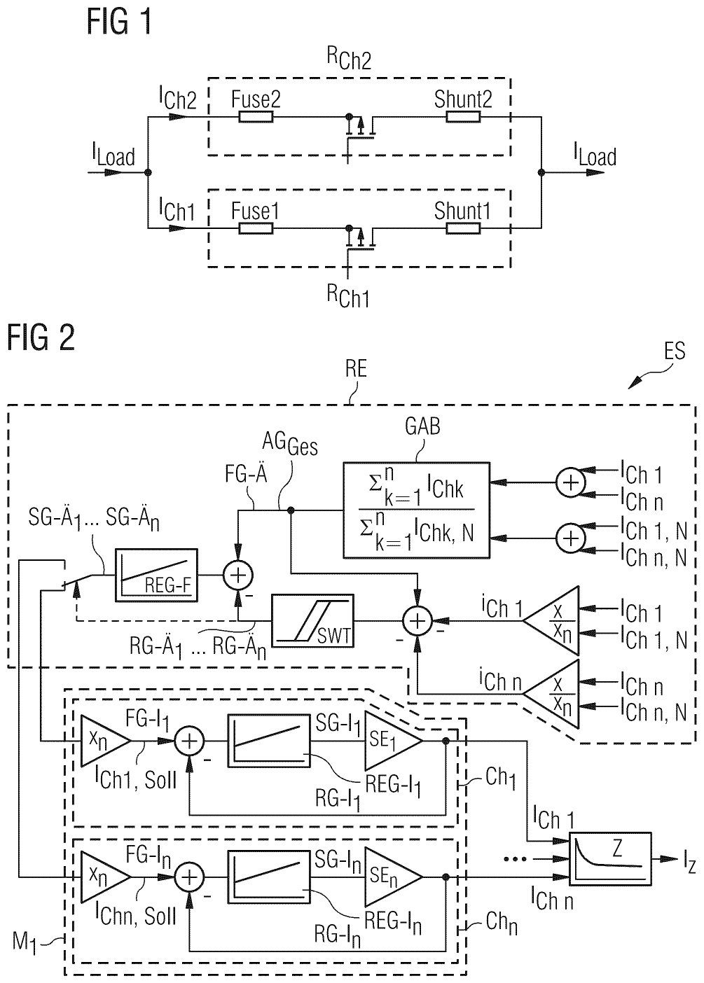

### DETAILED DESCRIPTION OF THE EXEMPLARY EMBODIMENTS

FIG. 2 shows a circuit diagram of an exemplary first embodiment of an electronic fuse ES in accordance with the invention. The electronic fuse ES comprises a first set M₁ of output channels Ch₁ . . . Chₙ. A first output channel Ch₁, comprising a first current regulator REG-I₁ and a first switching element SE₁, and an n-th output channel Chₙ, comprising an n-th current regulator REG-Iₙ and an n-th switching element SEₙ are shown. A switching element SE₁ . . . SEₙ can be used to designate a general power section. The three dots shown in FIG. 2 are symbolic of further output channels that are included in the first set M₁. This is a diagrammatic view of a plurality of output channels Ch₁ . . . Chₙ that are included in the first set M₁. A first number NM₁ of output channels in the first set M₁ is greater than or equal to two.

The output channels Ch₁ . . . Chₙ of the first set M₁ are connected in parallel to their outputs and jointly supply a load Z. A supply voltage is fed via each of the output channels Ch₁ . . . Chₙ of the first set M₁ to an output assigned to the respective output channel Ch₁ . . . Chₙ.

The current regulators REG-I₁ . . . REG-Iₙ are configured to determine an internal manipulated variable SG-I₁ . . . SG-Iₙ for the switching element SE₁ . . . SEₙ in its output channel Ch₁ . . . Chₙ from a difference between an internal reference variable FG-I₁ . . . FG-Iₙ and an internal control variable RG-I₁ . . . RG-Iₙ. The internal reference variable FG-I₁ . . . FG-Iₙ is provided by a controller RE or by the master controller REG-F of the controller RE as an external manipulated variable SG-Ä₁ . . . SG-Äₙ. The external manipulated variable SG-Ä₁ . . . SG-Äₙ is a current setpoint i_{Ch1,Soll} . . . i_{chn,Soll} related to the respective rated current I_{Ch1,N} . . . I_{Chn,N} of the output channel Ch₁. In this exemplary embodiment, the output channels Ch₁ . . . Chₙ therefore each comprise a de-scaler xₙ, which converts the referenced current setpoint i_{Ch1,Soll} . . . i_{Chn,Soll} into a non-referenced or de-scaled current setpoint I_{Ch1,Soll} . . . I_{Chn,Soll}. The internal control variable RG-I₁ . . . RG-Iₙ is an instantaneous output current I_{Ch1} . . . I_{Chn} in the respective output channel Ch₁ . . . Chₙ. The internal control variable RG-I₁ . . . RG-Iₙ or the instantaneous output current I_{Ch1} . . . I_{Chn} is fed back via an internal control loop. The current regulators REG-I₁ . . . REG-Iₙ each comprise an internal control loop and form a cascade control with a controller RE.

The controller RE is also shown. The controller RE is superordinate to the current regulators REG-I₁ . . . REG-Iₙ. The current regulators REG-I₁ . . . REG-Iₙ form a cascade control with the controller. The controller RE determines a second set M₂ of output channels Ch₁ . . . Chₙ. The second set M₂ is a subset of the first set M₁, where a second number N_{M2} of output channels Ch₁ . . . Chₙ in the second set M₂ is at least one less than the first number N_{M1}, and the second set M₂ includes at least those output channels Ch₁ . . . Chₙ with the highest output channel utilization level AG_{Ch1} . . . AG_{Chn} and not including at least those output channels Ch₁ . . . Chₙ with the lowest output channel utilization level AG_{Ch1} . . . AG_{Chn}. This means that, for a first number N_{M1} of output channels Ch₁ . . . Chₙ in the first set M₁ of, for example, two, a second number N_{M2} of output channels Ch₁ . . . Chₙ in the second set M₂ is, for example, one. For a first number N_{M1} of, for example, three, a second number N_{M2} is, for example, two or one. At least the output channel Ch₁ . . . Chₙ with the lowest output channel utilization level AG_{Ch1} . . . AG_{Chn} not being included in the second set M₂ and therefore not being controlled by the controller RE for load balancing ensures that this output channel Ch₁ . . . Chₙ assumes a current when one or more other output channels Ch₁ . . . Chₙ are shut down and its output channel utilization level AG_{Ch1} . . . AG_{Chn} increases. In addition, the load is therefore decisive for the output current I_{Z} in every operating position.

The controller RE comprises a master controller REG-F. The master controller REG-F determines at least one external manipulated variable SG-Ä₁ . . . SG-Äₙ, which is provided as at least one internal reference variable FG-I₁ . . . FG-Iₙ to the current regulators REG-I₁ . . . REG-Iₙ of the output channels Ch₁ . . . Chₙ of the second set M₂. The at least one internal reference variable FG-I₁ . . . FG-Iₙ corresponds to a current setpoint I_{Ch1,Soll} . . . I_{Chn,Soll} for the respective output channel Ch₁ . . . Chₙ. The master controller REG-F can determine different internal reference variables FG-I₁ . . . FG-Iₙ for a plurality of output channels Ch₁ . . . Chₙ and provide these to the output channels Ch₁ . . . Chₙ.

In this exemplary embodiment, the external reference variable FG-Ä is an overall utilization level AG_{Ges} of the first set M₁ of the output channels Ch₁ . . . Chₙ, where the controller RE is configured to form the overall utilization level AG_{Ges} as a ratio between the sum of the instantaneous output currents I_{Ch1} . . . I_{Chn} of the output channels Ch₁ . . . Chₙ of the first set M₁ to the sum of the rated currents I_{Ch1,N} . . . I_{Chn,N} of the output channels Ch₁ . . . Chₙ of the first set M₁, and the external control variable RG-Ä₁ . . . RG-Äₙ assigned to the output channel Ch₁ . . . Chₙ is in each case a difference between the overall utilization level AG_{Ges} and the output channel utilization level AG_{Ch1} . . . AG_{Chn} of the output channel Ch₁ . . . Chₙ. The output channel utilization levels AG_{Ch1} . . . AG_{Chn} are determined via scaling or a reference in each case of the instantaneous output current I_{Ch1} . . . I_{Chn} to the rated current I_{Ch1,N} . . . I_{Chn,N}. The subtraction is shown in diagrammatic view in FIG. 2, i.e., a difference is formed for each of the output channels Ch₁ . . . Chₙ between the overall utilization level AG_{Ges} and the output channel utilization level I_{Ch1,Soll} . . . I_{Chn,Soll}. Alternatively, this relationship could be shown with a plurality of subtractors.

The controller RE is configured to determine the second set M₂ based on various criteria. These criteria can be, for example, the output channel utilization levels AG_{Ch1} . . . AG_{Chn} of the output channels Ch₁ . . . Chₙ, the deviations of the output channel utilization levels AG_{Ch1} . . . AG_{Chn} of the output channels Ch₁ . . . Chₙ from an overall utilization level AG_{Ges}, the reaching or exceeding of a threshold value of an external control variable RG-Ä₁ . . . RG-Äₙ or a temperature in one of the output channels Ch₁ . . . Chₙ. The result of determining the second set M₂ is shown diagrammatically by a dashed arrow that acts on a switch or changeover switch shown in a diagrammatic view. This is intended to show that an external manipulated variable SG-Ä₁ . . . SG-Äₙ is determined by the controller RE or the master controller REG-F for each output channel Ch₁ . . . Chₙ of the second set and is output to the respective output channel Ch₁ . . . Chₙ. If a second number N_{M2} of output channels Ch₁ . . . Chₙ in the second set M₂ is greater than or equal to two, a plurality of different external manipulated variables SG-Ä₁ . . . SG-Äₙ is determined, each of which is assigned to an output channel Ch₁ . . . Chₙ of the second set M₂ and output to this. The controller RE or the master controller REG-F can thus be regarded as a multiplexer which determines different external manipulated variables SG-Ä₁ . . . SG-Äₙ from various differences between an external reference variable FG-Ä and different external control variables RG-Ä₁ . . . RG-Äₙ and outputs these to the output channel Ch₁ . . . Chₙ or the output channels Ch₁ . . . Chₙ of the second set.

The internal reference variables FG-I₁ . . . FG-Iₙ, control variables RG-I₁ . . . RG-Iₙ and manipulated variables SG-I₁ . . . SG-Iₙ can also be referred to as subordinate reference, control and manipulated variables because they act in control loops that are subordinate to the superordinate controller RE. The respective external reference variable FG-Ä, control variables RG-Ä₁ . . . RG-Äₙ and manipulated variables SG-Ä₁ . . . SG-Äₙ can also be referred to as superordinate reference variables, control variables and manipulated variables because they act in the controller RE and thus in the control loops superordinate to the current regulators REG-I₁ . . . REG-Iₙ.

In order to be able to performed managed load balancing, a separate control concept, including an adapted algorithm, must be developed. The electronic fuse ES comprises current regulators REG-I₁ . . . REG-Iₙ in analog or digital form in order to be able to limit currents in the event of an overload. Active balancing in the output channel Ch₁ . . . Chₙ is implemented with these current regulators REG-I₁ . . . REG-Iₙ and load balancing is performed with a superordinate cascade controller or with a superordinate controller RE.

In the superordinate controller, the currents I_{Chn} in the individual output channels Ch₁ . . . Chₙ are measured and totaled. This refers to the currents that flow through the switching elements SE₁ . . . SEₙ. As the sum of the currents in the individual output channels Ch₁ . . . Chₙ results in the load current I_{Z} in accordance with the relationship:

$${I}_{Z} = {\sum }_{k = 1}^{n} {I}_{C h k}$$

via the sum of the individual nominal values I_{Chn,N} in accordance with the relationship:

$${\sum }_{k = 1}^{n} {I}_{C h k , N}$$

a degree of utilization of the system AG_{Ges} can be determined via scaling in accordance with the relationship:

$${AG}_{Ges} = \frac{{\sum }_{k = 1}^{n} {I}_{Chk}}{{\sum }_{k = 1}^{n} {I}_{Chk , N}}$$

This value represents the current degree of utilization AG_{Ges} of the electronic fuse ES at any time as it is automatically adjusted as the load changes. This scaled value is therefore used as the external reference variable FG-A for the load balance controller or master controller REG-F. In principle, any scalable variable that provides information on the desired utilization of the electronic fuse ES is suitable, here.

At the same time or in close temporal proximity, the instantaneous output currents I_{Ch1} . . . I_{Chn} in the switching elements or output channels Ch₁ . . . Chₙ are scaled with their nominal value I_{Ch1,N} . . . I_{Chn,N}. This first provides information on the extent to which the individual switching element SE₁ . . . SEₙ or the individual output channel Ch₁ . . . Chₙ is utilized in relation to the respective nominal value i_{Chn}.

The deviation of the utilization of the respective output channel from the overall utilization level AG_{Ges} of the electronic fuse ES is then determined by subtraction in accordance with the relationship:

$$Δ {i}_{C h k} = A {G}_{G e s} - {i}_{C h k}$$

The output channel Ch₁ . . . Chₙ, the output channel utilization level AG_{Ch1} . . . AG_{Chn} of which is above the (ideal) overall utilization level AG_{Ges} of the electronic fuse ES, leads to relatively high instantaneous output current I_{Ch1} . . . I_{Chn} and is reduced.

Which output channel Ch₁ . . . Chₙ has the highest load relative to the overall utilization level AG_{Ges} can be seen, for example, from the fact that the corresponding deviation Δ_{iChn} is negative (Δ_{iChn}<0). This information is supplied to a decision-maker or threshold value trigger SWT, which selects the output channel Ch₁ . . . Chₙ or the switching element SE₁ . . . SEₙ that is actively controlled. If required, a threshold can also be defined here, above which the controller RE or the master controller REG-F intervenes or tolerates the definable deviation.

The relative deviation Δ_{iCh,ist} determined in this way is supplied to the master controller REG-F, in addition to the external reference variable FG-Ä or in this case, the overall utilization level AG_{Ges}, as a control deviation. This calculates the scaled external manipulated variable i_{Chk,soll}, which is then de-scaled, for example, via a DAC, and supplied to the current regulator REG-I₁ . . . REG-Iₙ of the output channel Ch₁ . . . Chₙ.

A major advantage of this arrangement is that only one output channel Ch₁ . . . Chₙ, switching element SE₁ . . . SEₙ or power section is actively in control mode at any one time. One output channel Ch₁ . . . Chₙ or switching element SE₁ . . . SEₙ or power section always remains fully switched through. Consequently, the output voltage does not drop.

As a result, the load remains decisive for the overall current I_{Z} in every operating position, and load jumps are possible at any time since the external reference variable AG_{Ges} is tracked by the scaling of the load situation.

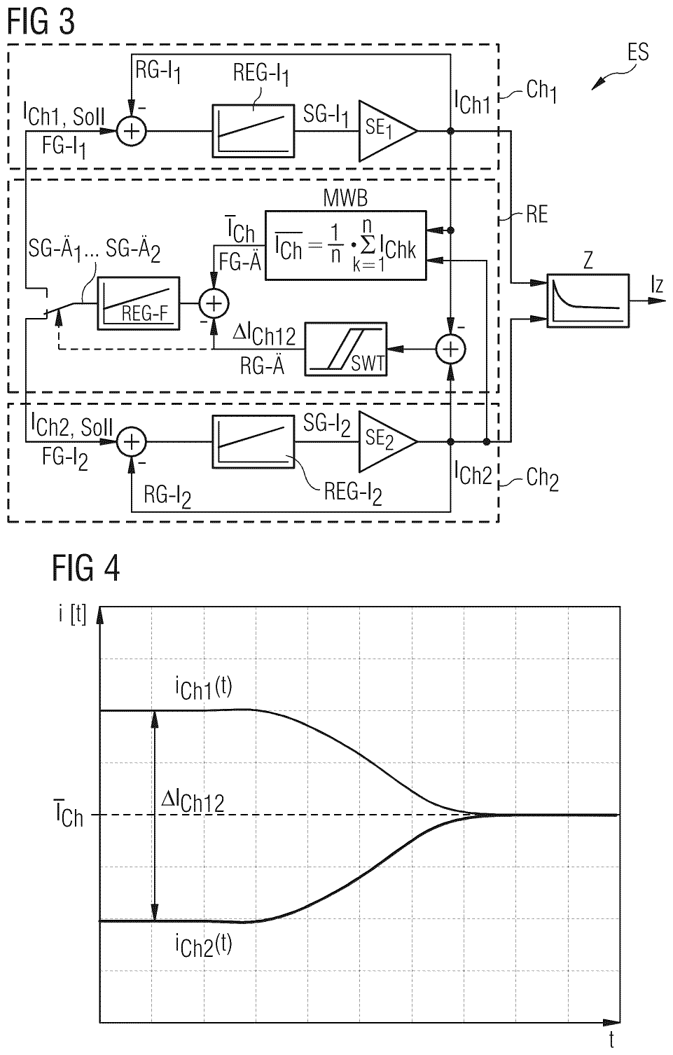

FIG. 3 shows a circuit diagram of an exemplary second embodiment of an electronic fuse ES in accordance with the invention. A controller, two output channels Ch₁ . . . Ch₂ and a load are shown. The two output channels Ch₁ . . . Ch₂ are connected in parallel and together feed the load Z. The output channels Ch₁ . . . Ch₂ each include a current regulator REG-I₁ . . . REG-I₂ and a switching element SE₁ . . . SE₂. In this embodiment, the controller RE is configured to form the external reference variable FG-Ä as the arithmetic mean of the instantaneous output currents Ī of the output channels Ch₁ . . . Ch₂ of the first set M₁, and to form the external control variable RG-A assigned to the output channel Ch₁ . . . Ch₂ as a difference ΔI_{Ch12} between the instantaneous output currents I_{Ch1} . . . I_{Ch2} of the output channels Ch₁ . . . Ch₂ of the first set M₁. Via a difference between the external reference variable FG-A and the external control variable RG-A, the controller RE determines an external manipulated variable SG-Ä₁ . . . SG-Ä₂, which is transmitted as the internal reference variable FG-I₁ . . . FG-I₂ to the current regulator REG-I₁ . . . REG-I₂ of the output channel Ch₁ . . . Ch₂ of the second set M₂. In this exemplary embodiment, this output channel Ch₁ . . . Ch₂ is the output channel Ch₁ . . . Ch₂ with the higher output channel utilization level AG_{Ch1} . . . AG_{Ch2}. Whether the output channel is controlled also depends on whether the difference ΔI_{Ch12} between the instantaneous output currents I_{Ch1} . . . I_{Ch2} of the output channels Ch₁ . . . Ch₂ of the first set M₁ is greater than a predefinable or predefined threshold value.

The basic consideration of load balancing control is that the output channel Ch₁ . . . Ch₂, which carries the higher current, is reset.

From the component point of view, the switching element or MOSFET carries the higher current with lower R_{DS,on}. As described in the introduction, it may be assumed that this is the switching element SE₁ . . . SE₂ with a lower operating temperature. This means that in continuous operation, the MOSFET, which in any case has the lower temperature, is sent from conduction mode to linear mode. As soon as the MOSFET heats up in linear mode due to the higher power loss, it can be assumed that the current distribution ratio between the output channels Ch₁ . . . Ch₂ is reversed due to the increasing R_{DS,on}. The MOSFET in conduction mode would then assume the higher current and thus would be controlled. Thermal equalization is therefore to be expected and corresponding instabilities are avoided.

The actual task of the current regulator REG-I₁ . . . REG-Iₙ in power supply apparatuses or electronic fuses ES is to limit the current to a predefinable value in the event of an overload. This actual setpoint of the current regulator REG-I₁ . . . REG-I₂ is typically 1.5- to 1.8 times I_{Nenn} and therefore significantly above the rated current I_{Ch1,N} . . . I_{Ch2,N} of the output channel Ch₁ . . . Chₙ, or above the predefinable setting. The reason for this is that load peaks occurring during operation that do not endanger system operation should be permitted without actively intervening as this can lead to undesirable effects.

If load balancing in parallel operation were to address both output channels Ch₁ . . . Ch₂ simultaneously and reset this (common) setpoint, it would be very difficult to ensure that overloads occurring during operation are reduced unintentionally.

For these reasons, it makes sense to establish the control such that only one MOSFET in the parallel network is actively in current limiting or linear mode. The task of the control is to determine an external manipulated variable SG-Ä₁ . . . SG-Ä₂ that can be transmitted to the internal control loop or the current regulators REG-I₁ . . . REG-I₂ via the external control loop or the controller RE or the master controller REG-F as a setpoint or internal reference variable FG-I₁ . . . FG-I₂.

The external reference variable FG-A is the setpoint of the external control loop of the cascade or the controller RE and is not easy to define for load balancing. Moreover, the same question applies to the external control variable RG-Ä₁ . . . RG-Ä₂. Ultimately, it is necessary to establish what is controlled in order to achieve load balancing between the output channels Ch₁ . . . Ch₂. This consideration is shown in FIG. 4.

FIG. 4 shows a graphical plot of the current of two output channels Ch₁ . . . Ch₂ of an electronic fuse ES in accordance with the invention in the second embodiment or the approach of defining the mean of the instantaneous output currents of both output channels Ch₁ . . . Ch₂ as the external reference variable FG-Ä. The consideration behind this is that each output channel Ch₁ . . . Ch₂ should carry half of the current. In n-channel systems, each output channel Ch₁ . . . Chₙ should carry the same proportion in a ratio of 1/n, provided that the output channels Ch₁ . . . Chₙ are made in the same way, i.e., have the same rated current, for example.

When different types of switching elements or transistor technologies are connected in parallel, the control can be adapted such that the instantaneous output currents are distributed favorably according to the circumstances.

The advantages of averaging the output currents as an external reference variable FG-A are twofold. The load current is specified by the user and can also change over time. With unequal current distribution in the output channels Ch₁ . . . Chₙ, the mean of the instantaneous output currents I_{Ch1} . . . I_{Ch2} in the output channels Ch₁ . . . Chₙ does not influence the total current, i.e., the total current, i.e., the current I_{Z} specified by the load Z corresponds to both the sum of the unequal instantaneous output currents I_{Ch1} . . . I_{Ch2} in the output channels Ch₁ . . . Ch₂ and to twice the mean Ī.

$${I}_{Z} = {I}_{C h 1} + {I}_{C h 2} = {\overline{I}}_{Ch}$$

This ensures that the external reference variable FG-Ä follows the time-varying load. Finally, the second advantage of a discrete-time implementation is that a pre-filter of the external reference variable FG-Ä is implemented at the same time via averaging, which avoids instabilities caused by high dynamic processes.

Based on the selection of the mean of the instantaneous output currents Ī in the output channels Ch₁ . . . Ch₂ as the external reference variable FG-A, the difference of the instantaneous output currents I_{Ch1} . . . I_{Ch2} between the output channels Ch₁ . . . Ch₂ is defined as control deviation (difference) and thus as the external control variable RG-A. The gain factor KR of the controller can be used to determine the dynamics of the external control loop.

The advantage of the difference between the instantaneous output currents I_{Ch1} . . . I_{Ch2} as a control difference is that important information for the control algorithm can be derived directly from it. As mentioned previously, the concept aims to ensure that the output channel Ch₁ . . . Chₙ which carries the higher instantaneous output current I_{Ch1} . . . I_{Ch2} is always controlled.

If the calculation of the control difference results in a negative value, then this means that it must involve the (also an) output channel Ch₁ . . . Ch₂ that carries a lower instantaneous output current I_{Ch1} . . . I_{Ch2} and should therefore not be controlled. This is shown in FIG. 3 by the dashed line that actuates the setpoint switch.

A further advantage of this approach is that a threshold value can be introduced, above which the master controller REG-F should become active. This enables the achievement of a certain level of insensitivity for small deviations. Typical threshold values for this are several 100 mA, up to a few amperes in high-current applications. This response threshold can be flexibly adjusted to the respective circumstances.

The introduction of a response threshold and the associated tolerance of a certain control deviation allows the use of simple controller types as REG-F master controllers, such as P-controllers. These simple controller types have a positive effect on the control stability of the cascade control as the phase response of the REG-F master controller does not add any new poles to the system. However, if the amplitude response is increased or decreased, it must be taken into account that a phase or amplitude reserve is still affected.

In applications in which a smaller control deviation or no control deviation can be tolerated, a controller type with an integrated I-component (if not included in the section) must be used. However, attention must be paid to the stability of the control.

In an alternative embodiment, the difference between the instantaneous output current of the output channel Ch₁ . . . Chₙ and the external reference variable FG-Ä can also be used as the control deviation or external control variable FG-Ä. This essentially contains the same information as the difference between the instantaneous currents I_{Ch1} . . . I_{Ch2} in the output channels Ch₁ . . . Ch₂.

FIG. 5 shows an exemplary flow chart of steps that are performed by the electronic fuse ES in the second embodiment.

These steps are preferably implemented digitally in firmware, but can also be implemented in another form, for example analog form, if required.

Initially, a check is performed to determine whether there is a parallel connection of two or more output channels Ch₁ . . . Chₙ. This step is performed in all embodiments and can, for example, occur using the method disclosed in EP 4 375 680 A1. Alternatively, for example, switches or data lines can be provided, with which a parallel connection of output channels Ch₁ . . . Chₙ of the power supply apparatus or the electronic fuse ES can be made known.

The instantaneous output currents I_{Ch1} . . . I_{Ch2} of the output channels Ch₁ . . . Chₙ are then measured and their difference ΔI_{Ch12} is calculated. If the difference is above a predefinable or predefined threshold value ΔI_{Trig}, then the controller is active. As already described, only the output channel Ch₁ . . . Chₙ that carries the higher instantaneous output current I_{Ch1} . . . I_{Ch2} or has the higher output channel utilization level ΔG_{Ch1} . . . ΔG_{Ch2} should switch to active control mode. This is checked, for example, by comparing variables or checking whether the difference is positive.

If one of the conditions is not met, then the operation is cancelled. If the preconditions are met, then the calculations for the respective current regulator REG-I₁ . . . REG-I₂ are performed. First, a setpoint is calculated as the arithmetic mean of the instantaneous output currents Ī. The block “Calc I_{Ch1,Soll}” represents a sub-function in which the master controller is implemented.

As this is a cascaded control, the external manipulated variable SG-Ä₁ . . . SG-Ä₂, the output variable of the master controller REG-F, of the external control loop is synonymous with the setpoint of the internal control loop, i.e., the internal reference variable FG-I₁ . . . FG-I₂. Hence, the designation “Calc I_{Ch1,Soll}”. The realization of the controller RE or the master controller REG-F is part of the implementation and depends on the conditions of the application. Depending on the control accuracy requirements, simple, non-recursive controllers (P-controllers) through to complex Proportional-Integral-Derivative (PID) Controllers are used. With recursive controller types, in addition to the calculation of the external manipulated variable SG-Ä₁ . . . SG-Ä₂, the storage of the recursive values is also necessary as an intermediate step.

Finally, as the last step, the external manipulated variable SG-Ä₁ . . . SG-Ä₂ is transferred to the internal control loop as the setpoint, i.e., as the internal reference variable FG-I₁ . . . FG-I₂. With a digital implementation of the external control loop, this is done, for example, via a digital-analog conversion method.

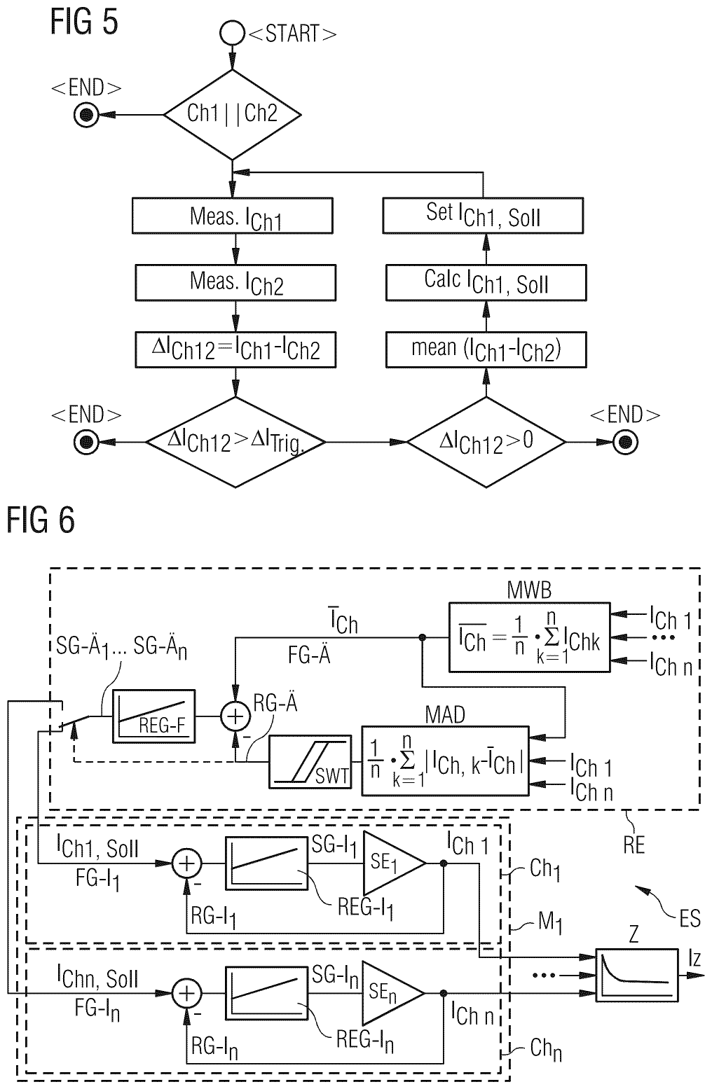

FIG. 6 shows a circuit diagram of an exemplary third embodiment of an electronic fuse in accordance with the invention.

The external reference variable FG-A is an arithmetic mean of the instantaneous output currents I_{Ch1} . . . I_{Chn} of the output channels Ch₁ . . . Chₙ of the first set M₁, and the external control variable RG-Ä₁ . . . RG-Äₙ assigned to the output channel Ch₁ . . . Chₙ is a mean absolute deviation of the instantaneous output currents I_{Ch1} . . . I_{Chn} of the output channels Ch₁ . . . Chₙ of the first set from the arithmetic mean of the instantaneous output currents I_{Ch1} . . . I_{Chn} of the output channels Ch₁ . . . Chₙ of the first set M₁.

Above three output channels Ch₁ . . . Chₙ, the mean absolute deviation from the arithmetic mean dx (MAD, Mean Absolute Deviation) is suitable for this purpose. This is formed by the unit for forming the mean absolute deviation from the arithmetic mean. The MAD is defined by the relationship:

$${d}_{\overline{x}} = \frac{1}{n} {\sum }_{k = 1}^{n} \vert {i}_{c h , n} - {\overline{I}}_{c h} \vert$$

and thus describes the average deviation of the instantaneous output current of each output channel Ch₁ . . . Chₙ from the mean and is therefore a good illustration of the control difference.

The controller concept will be adjusted for an implementation with several output channels Ch₁ . . . Chₙ. The basic concept of cascade control remains unchanged. The principle that those output channels Ch₁ . . . Chₙ that carry the higher instantaneous output current I_{Ch1} . . . I_{Chn} are reduced is also retained.

However, just as in the first embodiment, the higher number of output channels Ch₁ . . . Chₙ results in the additional degree of freedom to actively control several output channels Ch₁ . . . Chₙ. The threshold value trigger thus has the additional task as the decision-maker regarding which output channels Ch₁ . . . Chₙ are to be actively controlled. This makes it possible to expand a Multiple Input Single Output (MISO) system into a Multiple Input Multiple Output (MIMO) system.

However, the control algorithm would only change insignificantly. The control deviation is no longer calculated via subtraction, but via determination of the mean absolute deviation from the arithmetic mean MAD.

The mean absolute deviation from the arithmetic mean MAD essentially contains the same information for the threshold value trigger that a decision-maker would then have implemented, if necessary, to determine which output channels Ch₁ . . . Chₙ are now actively controlled.

The external manipulated variable SG-Ä₁ . . . SG-Äₙ is then determined and transferred to the corresponding output channels Ch₁ . . . Chₙ.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A power supply apparatus, comprising:
a first set of output channels; and
a controller for load balancing between the output channels of the first set;
wherein a first number of output channels in the first set is greater than or equal to two;
wherein the output channels of the first set each comprise a current regulator and a switching element;
wherein each current regulator is configured to control the switching element in a respective output channel;
wherein the output channels of the first set each have an instantaneous output current and a rated current;
wherein the output channels of the first set are connectable in parallel; and
wherein the controller is configured, in cases of a parallel connection of at least two output channels of the first set to:
detect instantaneous output currents of the output channels of the first set,
determine output channel utilization levels of the output channels of the first set, a respective output channel utilization level being a ratio between the instantaneous output current and the rated current of the respective output channel,
determine a second set of output channels, the second set being a subset of the first set, a second number of the output channels in the second set being at least one less than the first number, and the second set comprising at least that output channel with a highest output channel utilization level and not comprising at least that output channel with a lowest output channel utilization level, and
control the current regulator of the output channels of the second set such that output channel utilization levels of the output channels of the second set decrease and load balancing occurs between the output channels of the first set.

2. The power supply apparatus as claimed in claim 1, wherein the switching elements are electronic switches; and wherein the current regulators are configured to set the switching element in the respective output channel to a current limiting mode such that the instantaneous output current of the respective output channel is limited.

3. The power supply apparatus as claimed in claim 2, wherein the current limiting mode is a linear mode or a pulsed mode.

4. The power supply apparatus as claimed in claim 2, wherein the electronic switches are one of field-effect transistors, bipolar transistors and Insulated Gate Bipolar Transistors (IGBTs).

5. The power supply apparatus as claimed in claim 3, wherein the electronic switches are one of field-effect transistors, bipolar transistors and Insulated Gate Bipolar Transistors (IGBTs).

6. The power supply apparatus as claimed in claim 1, wherein the controller is configured to provide each current regulator of the second set with an internal reference variable; and wherein the internal reference variable is a current setpoint which is dependent on the output channel utilization level of the output channel associated with the current regulator.

7. The power supply apparatus as claimed in claim 6, wherein the current regulators of the first set are configured to determine an internal manipulated variable for the switching element in the respective output channel from a difference between the internal reference variable and an internal control variable, which is formed by the instantaneous current in the respective output channel associated with the current regulators.

8. The power supply apparatus as claimed in claim 6, wherein the controller is configured to determine the internal reference variable for the current regulators of the second set from a difference between an external reference variable and an external control variable assigned to the respective output channel of the current regulators.

9. The power supply apparatus as claimed in claim 7, wherein the controller is configured to determine the internal reference variable for the current regulators of the second set from a difference between an external reference variable and an external control variable assigned to the respective output channel of the current regulators.

10. The power supply apparatus as claimed in claim 8, wherein the external reference variable is an overall utilization level of the first set of output channels;
wherein the controller is further configured to form the overall utilization level as a ratio between a sum of the instantaneous output currents of the output channels of the first set to a sum of rated currents of the output channels of the first set; and
wherein the external control variable assigned to the output channel is in each case a difference between the overall utilization level and the output channel utilization level of the output channel.

11. The power supply apparatus as claimed in claim 8, wherein the external reference variable is an arithmetic mean of the instantaneous output currents of the output channels of the first set; and wherein the external control variable assigned to the output channel is a difference between the instantaneous output currents of the output channels of the first set.

12. The power supply apparatus as claimed in claim 8, wherein the external reference variable is an arithmetic mean of the instantaneous output currents of the output channels of the first set; and wherein the external control variable assigned to the output channel is in each case a mean absolute deviation of the instantaneous output currents of the output channels of the first set from the arithmetic mean of the instantaneous output currents of the output channels of the first set.

13. The power supply apparatus as claimed in claim 7, wherein the controller is further configured to control the current regulators of the output channels of the second set as a function of reaching or exceeding a threshold value of the external control variable.

14. The power supply apparatus as claimed in claim 1, wherein the power supply apparatus is an electronic fuse for a power supply.

15. The power supply apparatus as claimed in claim 1, wherein at least the output channel with a lowest output channel utilization level is not included in the second set and is therefore not controlled by the controller for load balancing.
